(19) United States
(12) Patent Application Publication
(10) Pub. No.: US 2026/0077377 A1
(43) Pub. Date: Mar. 19, 2026

(54) SLOT DIE, SLOT DIE TEMPERATURE CONTROL APPARATUS, AND SLOT DIE TEMPERATURE CONTROL METHOD

(71) Applicant: SAMSUNG SDI CO., LTD., Yongin-si (KR)

(72) Inventor: Jun Hyeok KWAK, Yongin-si (KR)

(21) Appl. No.: 19/210,319

(22) Filed: May 16, 2025

(30) Foreign Application Priority Data
Sep. 19, 2024 (KR) 10-2024-0126971

(51) Int. Cl. B05C 5/02; B05C 11/10

(52) U.S. Cl. CPC B05C 5/0254; B05C 11/1015

(57) ABSTRACT

A slot die, a slot die temperature control apparatus, and a slot die control method are provided. The slot die includes an upper die, a lower die configured to form a gap with the upper die, a slurry supply unit configured to be connected to an external slurry supply source, one or more cavities formed in the lower die and connected to the slurry supply unit, a slot connected to the one or more cavities to coat a slurry on a base material. The slot die also includes a temperature sensor configured to measure a temperature of the slurry and a temperature controller provided adjacent to the slot, with the temperature controller configured to control a temperature of the slurry discharged from the slot based on the temperature measured by the temperature sensor.

### CROSS-REFERENCE TO RELATED APPLICATIONS

This application claims priority to and the benefit of the Korean Patent Application No. 10-2024-0126971 filed on Sep. 19, 2024, which is hereby incorporated by reference as if fully set forth herein.

### BACKGROUND

### Field of the Disclosure

The present disclosure relates to a slot die, a slot die temperature control apparatus, and a slot die temperature control method. More particularly, to a slot die that includes a temperature controller disposed adjacent to a slot to control a temperature of a slurry discharged from the slot, and corresponding a slot die temperature control apparatus and slot die temperature control method.

### Discussion of the Related Art

Unlike primary batteries that are not designed to be charged, secondary batteries can to be discharged and recharged. Low-capacity secondary batteries are used in small portable electronic devices, such as smart phones, feature phones, notebook computers, digital cameras, and camcorders, while large-capacity secondary batteries are widely used as power sources for driving motors, such as of hybrid vehicles or electric vehicles, and for power storage. A secondary battery includes an electrode assembly that includes a positive electrode and a negative electrode, a case that accommodates the electrode assembly, a terminal part connected to the electrode assembly, etc.

in particular, secondary batteries include an electrode assembly provides a current, a case that accommodates the electrode assembly and an electrolyte, a cap plate that is coupled to an opening of the case, and an electrode terminal through which the electrode assembly is connected to outside of the case and cap plate.

The electrode assembly may be formed as a winding type or a stack type. In such cases, electrodes are disposed at both sides of a separator which is an electrical insulator and the separator and the electrodes are wound or stacked, or may be formed in a combination structure thereof. The separator isolates electrodes having different polarities in the electrode assembly and continuously maintains an ion conductance, thereby enabling charging and discharging of the electrode assembly.

Electrodes are formed by coating an active material slurry on a base material. Slot dies are used in coating the active material slurry on the base material to manufacture the electrode. Slot dies include a lower block and an upper block, which form a chamber for supplying an active material slurry and set a height of a slot discharging the active material slurry. A seam member is provided between the lower block and the upper block to set a width of the slot.

In a coating process, a distribution of a coating loading level occurs due to a temperature change of a slurry. Due to this change in distribution, it is difficult to manage product quality. In the related art, a distribution of a coating loading level is reduced through control based on a process factor such as revolutions per minute (RPM) of a pump or a die gap. However, in this art there is a problem where a control of the process is changed due to a slurry temperature deviation over time and a reduction in process capability occurs during a long period or and a short period.

The information disclosed in this section is for enhancement of understanding of the background of the present disclosure, and therefore, it may contain information that does not constitute related (or prior) art.

### SUMMARY

An aspect of the present disclosure is directed to providing a slot die that includes a temperature controller disposed adjacent to a slot to control a temperature of a slurry discharged from the slot, and a corresponding slot die temperature control apparatus and slot die temperature control method.

The technical problems to be solved by the present disclosure is not limited to those described above, and other problems not mentioned herein, and aspects and features of the present disclosure that would address such problems, will be clearly understood by those skilled in the art from the description of the present disclosure below.

A slot die according to embodiments may include an upper die; a lower die forming a gap with the upper die; a slurry supply unit configured to be connected to an external slurry supply source; one or more cavities formed in the lower die and connected to the slurry supply unit; a slot connected to the one or more cavities and configured to coat a slurry on a base material; ; a temperature measurer configured to measure the temperature of the slurry; a temperature controller provided adjacent to the slot and configured to control a temperature of the slurry discharged from the slot based on the temperature measured by the temperature sensor.

The temperature controller may be provided in the upper die, the lower die, or both the upper die and the lower die.

The temperature controller may include a fluid flow tube forming a flow path through which a fluid for controlling the temperature of the slurry can flow.

The fluid flow tube extends in a width direction of the slot and pass through an inner portion of the upper die or the lower die.

The temperature controller may include: a cooling unit configured to decrease a temperature of the fluid supplied through the fluid flow tube; and a heating unit configured to increase the temperature of the fluid supplied through the fluid flow tube.

The temperature sensor may be configured to measure a temperature of a slurry supplied from a slurry in the slot die.

The temperature sensor may include a second temperature sensor configured to measure a temperature of the slurry discharged from the slot.

A slot die temperature control apparatus according to embodiments may include: a slot die including an upper die; a lower die forming a gap with the upper die; a slurry supply unit configured to be connected to an external slurry supply source; one or more cavities formed in the lower die and connected to the slurry supply unit; a slot connected to the one or more cavities to coat a slurry on a base material; a temperature controller provided adjacent to the slot to control a temperature of the slurry discharged from the slot; and a temperature sensor configured to measure the temperature of the slurry; and a controller configured to control the temperature controller, based on the temperature of the slurry measured by the temperature sensor.

The temperature controller may be provided in one the upper die, the lower die, or both the upper die and the lower die.

The temperature controller may include a fluid flow tube forming a flow path through which a fluid for controlling the temperature of the slurry can flow.

The fluid flow tube may extend in a width direction of the slot and pass through an inner portion of the upper die or the lower die.

The temperature controller may include: a cooling unit configured to decrease a temperature of the fluid supplied through the fluid flow tube; and a heating unit configured to increase the temperature of the fluid supplied through the fluid flow tube.

The temperature sensor may be configured to measure a temperature of a slurry supplied from the slurry supply unit.

The temperature measurer may include a second temperature measurer configured to measure a temperature of the slurry discharged from the slot.

The controller may be configured to control the temperature controller so that the temperature of the slurry supplied from the slurry supply unit corresponds to the temperature of the slurry discharged from the slot.

A slot die temperature control method according to embodiments may include: a step of providing a slot die including an upper die; a lower die forming a gap with the upper die; a slurry supply unit connected to an external slurry supply source; one or more cavities formed in the lower die and connected to the slurry supply unit; a slot connected to the one or more cavities to coat a slurry on a base material; a temperature controller provided adjacent to the slot to control a temperature of the slurry discharged from the slot; and a temperature sensor configured to measure the temperature of the slurry; and a step of controlling the temperature controller, based on the temperature of the slurry measured by the temperature sensor.

The step of providing the slot die may include a step of providing the temperature controller in the upper die, the lower die, and the upper die and the lower die.

The step of providing the slot die may include a step of providing the temperature sensor configured to measure a temperature of a slurry in the slot die.

The step of providing the slot die may include a step of providing a second temperature sensor configured to measure the temperature of the slurry discharged from the slot.

The step of controlling the temperature controller may include a step of controlling the temperature controller so that the temperature of the slurry supplied from the slurry supply unit corresponds to the temperature of the slurry discharged from the slot.

According to embodiments of the present disclosure, a temperature controller may be disposed adjacent to a slot and may control a temperature of the slurry discharged from the slot. Thus distribution of a loading level between coating rows may be made uniform, a defect rate caused by a uneven distribution between coating rows may be reduced, and a process yield may be secured.

Moreover, according to embodiments of the present disclosure, a fluid flow tube for controlling a temperature of the slurry discharged from the slot may extend in a width direction of the slot and pass through an inner portion of an upper die or a lower die. Thus, the temperature controller may control a loading level of an edge portion and a center portion of the slot based on a temperature.

It is to be understood that both the foregoing general description and the following detailed description of the present disclosure are exemplary and explanatory.

### BRIEF DESCRIPTION OF THE DRAWINGS

The accompanying drawings, which are included to provide a further understanding of the disclosure and are incorporated in and constitute a part of this application, illustrate embodiments of the disclosure and together with the description explain principles of the disclosure.

FIGS. 1A, 1B, and 1C are diagram schematically illustrating a slot die temperature control apparatus according to embodiments of the present disclosure.

FIG. 2A is a diagram schematically illustrating an upper die and a lower die of a slot die temperature control apparatus according to embodiments of the present disclosure.

FIG. 2B is a diagram schematically illustrating a fluid flow of an upper die of a slot die of a slot die temperature control apparatus according to embodiments of the present disclosure.

FIG. 2C is a diagram schematically illustrating a fluid flow of an upper die of a slot die of a slot die temperature control apparatus according to embodiments of the present disclosure with respect to a backside.

FIG. 2D is a diagram schematically illustrating a fluid flow of a lower die of a slot die of a slot die temperature control apparatus according to embodiments of the present disclosure with respect to an upper side.

FIG. 2E is a diagram schematically illustrating a fluid flow of a lower die of a slot die of a slot die temperature control apparatus according to embodiments of the present disclosure with respect to a backside.

FIG. 3 is a diagram for describing a slot die temperature control method according to embodiments of the present disclosure.

### DETAILED DESCRIPTION OF THE INVENTION

Exemplary embodiments of the present disclosure will be described below in detail with reference to the accompanying drawings. It is noted that the terms or words used in this specification and claims should not be construed as being limited to common or dictionary meanings but instead should be understood to have meanings and concepts in agreement with the spirit of the present disclosure based on the principle that an inventor can define the concept of each term suitably in order to describe his/her own invention in the best way possible. Accordingly, since the embodiments described in this specification and the configurations illustrated in the drawings are only an example of the present disclosure and they do not cover all the technical ideas of the present disclosure, it should be understood that various changes and modifications may be made at the time of filing this application.

It will be further understood that the terms “comprises/includes” and/or “comprising/including” when used herein, specify the presence of stated features, integers, steps, operations, elements, components, and/or groups thereof, but do not preclude the presence or addition of one or more other features, integers, steps, operations, elements, components, and/or groups thereof.

In order to facilitate understanding of the present disclosure, the accompanying drawings are not drawn to scale and the dimensions of some components may be exaggerated. It should be noted that the same reference numerals are designated to the same components in different embodiments.

Reference to two compared elements, features, etc. as being “the same” means that they are “substantially the same”. Therefore, the phrase “substantially the same” may include a deviation that is considered low in the art, for example, a deviation of 5% or less. The uniformity of any parameter in a given region may mean that it is uniform from an average perspective.

Although the terms such as “first” and/or “second” are used to describe various components, these components are not limited by these terms, of course. These terms are only used to distinguish one component from another component. Thus, unless specifically stated to the contrary, a first component may be termed a second component without departing from the teachings of exemplary embodiments.

Throughout the specification, unless otherwise stated, each element may be singular or plural.

Arrangement of any component “above (or below)” or “on (or under)” a component may mean that any component is disposed in contact with the upper (or lower) surface of the component, as well as that other components may be interposed between the element and any element disposed on (or under) the element.

It will be understood that, when a component is referred to as being “connected”, “coupled”, or “joined” to another component, not only can it be directly “connected”, “coupled”, or “joined” to the other element, but also can it be indirectly “connected”, “coupled”, or “joined” to the other element with other elements interposed therebetween.

As used herein, the term “and/or” includes any and all combinations of one or more of the associate listed items. The use of “may” when describing embodiments of the present disclosure relates to “one or more embodiments of the present disclosure”. Expressions such as “at least one” and “one or more” preceding a list of elements modify the entire list of elements and do not modify the individual elements in the list.

Throughout the specification, when “A and/or B” is stated, it means A, B, or A and B, unless otherwise stated. In addition, when “C to D” is stated, it means C or more and D or less, unless specifically stated to the contrary.

When the phrase such as “at least one of A, B, and C”, “at least one of A, B, or C”, “at least one selected from the group of A, B, and C”, or “at least one selected from among A, B, and C” is used to designate a list of elements A, B, and C, the phrase may refer to any and all suitable combinations.

The term “use” may be considered synonymous with the term “utilize”. As used herein, the terms “substantially,” “about,” and similar terms are used as terms of approximation rather than as terms of degree, and are intended to account for inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Accordingly, a first element, component, region, layer, or section discussed below may be termed a second element, component, region, layer, or section without departing from the teachings of exemplary embodiments.

For ease of explanation in describing the relationship of one element or feature to another element(s) or feature(s) as illustrated in the drawings, spatially relative terms such as “beneath”, “below”, “lower”, “above”, and “upper” may be used herein. It will be understood that spatially relative positions are intended to encompass different directions of the device in use or operation in addition to the direction depicted in the drawings. For example, if the device in the drawings is turned over, any element described as being “below” or “beneath” another element would then be oriented “above” or “over” another element. Therefore, the term “below” may encompass both upward and downward directions.

The terminology used herein is for the purpose of describing embodiments of the present disclosure and is not intended to limit the present disclosure.

The present disclosure will be described in detail with reference to the attached drawings.

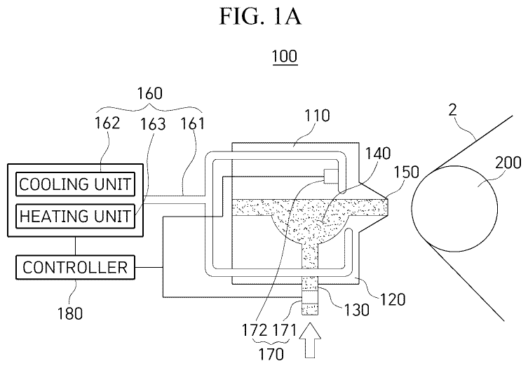

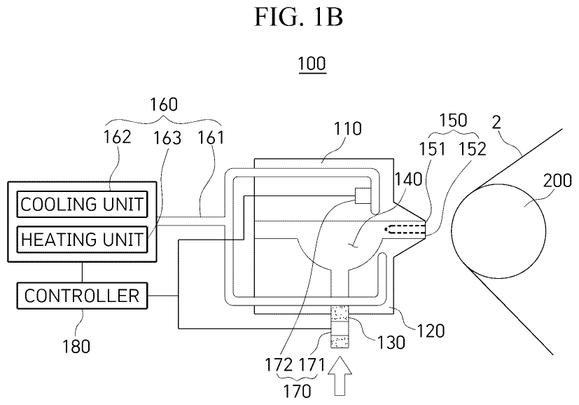

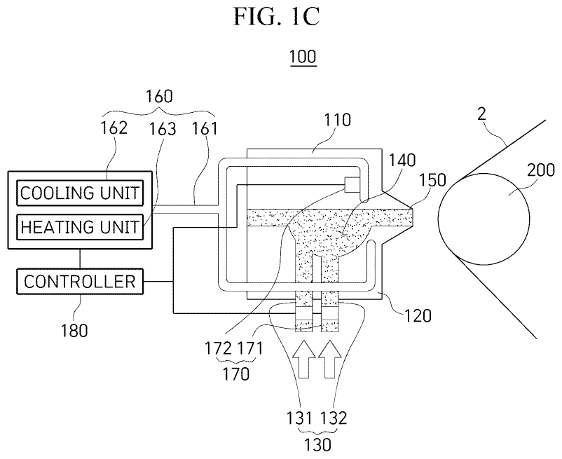

FIGS. 1A to 1C are diagrams schematically illustrating a slot die temperature control apparatus 100 according to embodiments of the present disclosure.

Referring to FIGS. 1A to 1C, the slot die temperature control apparatus 100 may include an upper die 110, a lower die 120, a slurry supply unit 130, one or more cavities 140, a slot 150, a temperature controller 160, a temperature sensor 170, and a controller 180. The slot die may be divided by the upper die 110 and the lower die 120, and the upper die 110 and the lower die 120 may form a gap which is a path through which a slurry 1 moves.

The slurry supply unit 130 may be connected to an external slurry supply source and may supply the slurry 1. In embodiments, the external slurry supply source may be a slurry tank. As shown in FIG. 1A, the slurry supply unit 130 may be configured as one, or as in FIG. 1C, the slurry supply unit 130 may be configured as more than one structure. That is, as shown in FIG. 1C, slurry supply units 131 and 132 may be connected to a plurality of external slurry supply sources.

The one or more cavities 140 may be formed in the lower die 120 and may be connected to the slurry supply unit 130. The cavities 140 may form a space where the slurry 1 supplied from the slurry supply unit 130 is held. In embodiments, a cross-sectional surface of each of the one or more cavities 140 may be formed in a semicircular shape. Also, in embodiments, the one or more cavities 140 may be formed in the upper die 110.

The slot 150 may be connected to the cavity 140 through a gap between the upper die 110 and the lower die 120. The slurry 1 may be passed through the gap in the process of being applied to a base material. That is, the slot 150 may be an outlet of the slurry 1 in the slot die. The slurry 1 discharged from the slot 150 may be applied to and coated on an electrode plate 2 which is transferred through a transfer drum 200. As in FIG. 1A, the slot 150 may be configured as one, or as in FIG. 1B, more than one slot 150 may be provided. Thus, in the embodiment depicted in FIG. 1B, the slurry 1 may be discharged through two slots 151 and 152 and may be applied to and coated on the electrode plate 2.

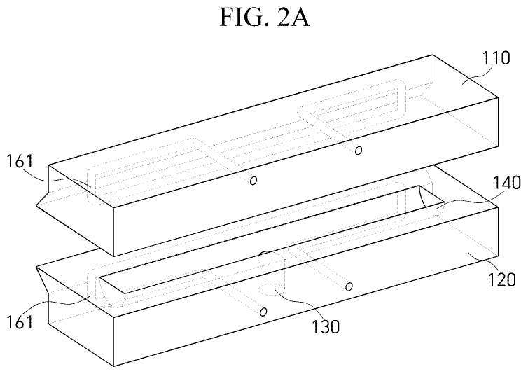

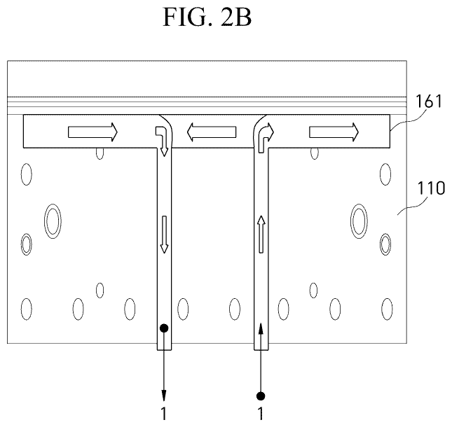

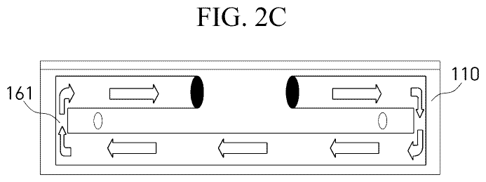

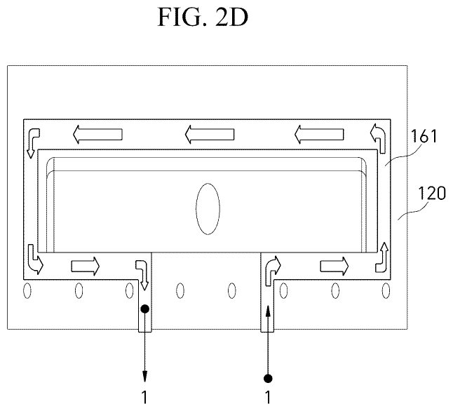

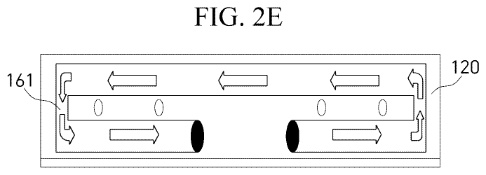

The temperature controller 160 may be disposed adjacent to the slot 150 and may control a temperature of the slurry 1 discharged from the slot 150. The slot die temperature control apparatus 100 according to embodiments of the present disclosure may maintain a temperature of the slurry 1 by using the temperature controller 160. In embodiments, the temperature controller 160 may be included in one or more of the upper die 110 and the lower die 120. The temperature controller 160 may include a fluid flow tube 161 which forms a flow path through which a fluid for controlling a temperature of the slurry 1 flows. A fluid flowing in the fluid flow tube 161 may be, for example, a heating medium oil functioning as a refrigerant or a heat medium. The detailed shape and arrangement of the fluid flow tube 161 will be described below with reference to FIGS. 2A to 2E.

In embodiments, the temperature controller 160 may include a cooling unit 162 which decreases a temperature of a fluid supplied to the fluid flow tube 161 and a heating unit 163 which increases a temperature of the fluid supplied to the fluid flow tube 161. When a temperature of the slurry 1 is too high, the cooling unit 162 may decrease a temperature of the fluid supplied to the fluid flow tube 161 to reduce a temperature of the slurry 1. When a temperature of the slurry 1 is too low, the heating unit 163 may increase a temperature of the fluid supplied to the fluid flow tube 161 to increase a temperature of the slurry 1. In embodiments, the cooling unit 162 may be a chiller, and the heating unit 163 may be a heater.

The temperature sensor 170 may measure a temperature of the slurry 1. In embodiments, the temperature sensor 170 may include a first temperature sensor 171 that measures a temperature of the slurry 1 supplied from the slurry supply unit 130 and a second temperature sensor 172 that measures a temperature of the slurry 1 discharged from the slot 150. Accordingly, a difference between a temperature of the slurry 1 supplied from the slurry supply unit 130 and a temperature of the slurry 1 discharged from the slot 150 may be checked. In embodiments, the second temperature measurer 172 may be included in the upper die 110.

The controller 180 may control the temperature controller 160 based on a temperature of the slurry 1 measured by the temperature sensor(s) 170. In embodiments, the controller 180 may control a temperature of a fluid supplied to the fluid flow tube 161 by using the cooling unit 162 and the heating unit 163 based on a temperature of the slurry 1 measured by the first temperature sensor 171 and the second temperature sensor 172.

FIG. 2A is a diagram schematically illustrating an upper die and a lower die of a slot die temperature control apparatus according to embodiments of the present disclosure, FIG. 2B is a diagram schematically illustrating a fluid flow of an upper die of a slot die of a slot die temperature control apparatus according to embodiments of the present disclosure, FIG. 2C is a diagram schematically illustrating a fluid flow of an upper die of a slot die of a slot die temperature control apparatus according to embodiments of the present disclosure on a backside, FIG. 2D is a diagram schematically illustrating a fluid flow of a lower die of a slot die of a slot die temperature control apparatus according to embodiments of the present disclosure on an upper side, and FIG. 2E is a diagram schematically illustrating a fluid flow of a lower die of a slot die of a slot die temperature control apparatus according to embodiments of the present disclosure on a backside.

Referring to FIGS. 2A to 2E, the upper die 110 and the lower die 120 of the slot die of the slot die temperature control apparatus 100 may each include the fluid flow tube 161. In embodiments, the fluid flow tube 161 may be provided to extend in a width direction of the slot 150 and pass through an inner portion of the upper die 110 or the lower die 120. Thus, as illustrated in FIGS. 2A to 2E, the fluid flow tube 161 may cool or heat all of the slurry 1 discharged from the slot 150 and thereby control a temperature of the slurry 1 discharged from the slot 150.

Referring to FIGS. 2A to 2C, a fluid may flow along the fluid flow tube 160 through an upper portion of a backside of the upper die 110 and then along a part of the fluid flow tube 161 extending in the width direction of the slot 150 near the slot 150 under a front side of the upper die 110. As such, a temperature of the slurry 1 discharged from the slot 150 may increase or decrease due to the fluid flowing through the fluid flow tube. After a temperature of the slurry 1 discharged from the slot 150 increases or decreases, the fluid may flow out through the upper portion of the backside of the upper die 110.

Referring to FIGS. 2A, 2D, and 2E, a fluid may flow in through a lower portion of a backside of the lower die 120 and along the fluid flow tube 161 extending in the width direction of the slot 150 near the slot 150 under a front side of the lower die 120. As such, a temperature of the slurry 1 discharged from the slot 150 may increase or decrease. After a temperature of the slurry 1 discharged from the slot 150 increases or decreases, the fluid may flow out through the lower portion of the backside of the lower die 120.

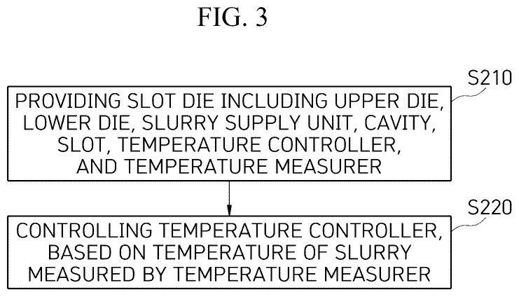

Hereinafter, a slot die temperature control method according to embodiments of the present disclosure, will be described in detail with reference to FIG. 3. The method may be performed by the controller 180 of the slot die temperature control apparatus according to embodiments of the present disclosure,

FIG. 3 is a diagram for describing a slot die temperature control method according to embodiments of the present disclosure. Referring to FIG. 3, the slot die temperature control method according to embodiments of the present disclosure may include step S210 and step S220.

In step S210 a slot die is provided that includes an upper die, a lower die forming a gap with the upper die, a slurry supply unit connected to an external slurry supply source, one or more cavities connected to the slurry supply unit, a slot connected to the cavity through the gap to coat a slurry on a base material, a temperature controller provided adjacent to the slot to control a temperature of the slurry discharged from the slot, and a temperature sensor measuring a temperature of the slurry. In embodiments, step S210 may providing a temperature controller in one or more of the upper die and the lower die. In other embodiments, step S210 may include providing a first temperature sensor measuring a temperature of the slurry supplied from the slurry supply unit. In other embodiments, step S210 may include a step of providing a second temperature sensor measuring a temperature of the slurry discharged from the slot.

In step S220, temperature control is performed based on a temperature of the slurry measured by the temperature sensor. In other embodiments, step S220 may include controlling the temperature controller so that a temperature of the slurry supplied from the slurry supply unit corresponds to a temperature of the slurry discharged from the slot.

The slot die temperature control method according to embodiments of the present disclosure has been described with reference to the flowchart in FIG. 3. To provide a simple description, the control method is illustrated as a series of blocks, but the present disclosure is not limited to the order of the blocks and some blocks may be provided simultaneously or an order that differs from the illustration and description of the present disclosure. Also, all blocks illustrated for implementing a method described herein may not be needed.

Furthermore, in the description given above with reference to FIG. 3, based on an implementation example of the present disclosure, each step may be further divided into additional steps, or may be combined into fewer steps. Also, some steps may be omitted depending on the case, or the order between steps may be changed. Furthermore, despite the other omitted descriptions, the descriptions of FIGS. 1 to 2E may be applied to the description of FIG. 3. Also, the description of FIG. 3 may be applied to the descriptions of FIGS. 1 to 2E.

According to embodiments of the present disclosure, the temperature controller may be disposed adjacent to a slot and may control a temperature of the slurry discharged from the slot. With such temperature control, a distribution of a loading level between coating rows can be made uniform. Thus, a defect rate caused by a uneven distributions of coating rows may be decreased and a good process yield may be secured.

Moreover, according to embodiments of the present disclosure, a fluid flow tube for controlling a temperature of the slurry discharged from the slot may be provided to extend in a width direction of the slot and pass through an inner portion of an upper die or a lower die. Thus, the temperature controller may control a loading level of an edge portion and a center portion of the slot based on a temperature of the slurry.

Hereinafter, materials which may be used during coating in the slot die and the slot die temperature control apparatus and method according to an embodiment of the present disclosure are described.

A compound (e.g., a lithiated intercalation compound) capable of reversible intercalation and deintercalation of lithium may be used as a positive electrode active material. Specifically, one type or more of complex oxides of metal, selected among cobalt, manganese, nickel, and a combination of them, and lithium may be used as the positive electrode active material.

The complex oxide may be lithium transition metal complex oxide. A detailed example of the complex oxide may include lithium nickel-based oxide, lithium cobalt-based oxide, lithium manganese-based oxide, a lithium ferrous phosphate-based compound, cobalt-free nickel-manganese-based oxide, or a combination of them.

For example, a compound that is represented as one of the following chemical formulas may be used: LiₐA_{1-b}X_{b}O_{2-c}D_{c} (0.90≤a≤1.8, 0≤b≤0.5, 0≤c≤0.05); LiₐMn_{2-b}X_{b}O_{4-c}D_{c} (0.90≤a≤1.8, 0≤b≤0.5, 0≤c≤0.05); LiₐNi_{1-b-c}Co_{b}X_{c}O_{2-α}D_{α} (0.90≤a≤1.8, 0≤b≤0.5, 0≤c≤0.5, 0<α<2); LiₐNi_{1-b-c}Mn_{b}X_{c}O_{2-α}D_{α} (0.90≤a≤1.8, 0≤b≤0.5, 0≤c≤0.5, 0<α<2); LiₐNi_{b}Co_{c}L¹_{d}GₑO₂ (0.90≤a≤1.8, 0≤b≤0.9, 0≤c≤0.5, 0≤d≤0.5, 0≤e≤0.1); LiₐNiG_{b}O₂ (0.90≤a≤1.8, 0.001≤b≤0.1); LiₐCoG_{b}O₂ (0.90≤a≤1.8, 0.001≤b≤0.1); LiₐMn_{1-b}G_{b}O₂ (0.90≤a≤1.8, 0.001≤b≤0.1); LiₐMn₂G_{b}O₄ (0.90≤a≤1.8, 0.001≤b≤0.1); LiₐMn_{1-g}G_{g}PO₄ (0.90≤a≤1.8, 0≤g≤0.5); Li_{(3-f)}Fe₂(PO₄)₃ (0≤f≤2); and LiₐFePO₄ (0.90≤a≤1.8). In the chemical formulas, A may be Ni, Co, Mn, or a combination thereof; X may be Al, Ni, Co, Mn, Cr, Fe, Mg, Sr, V, a rare earth element, or a combination thereof; D may be O, F, S, P, or a combination thereof; G may be Al, Cr, Mn, Fe, Mg, La, Ce, Sr, V, or a combination; and L¹ may be Mn, Al, or a combination thereof.

A positive electrode for a lithium secondary battery may include a current collector and a positive electrode active material layer formed on the current collector. The positive electrode active material layer may include the positive electrode active material and may further include a binder and/or a conductive material.

The amount of the positive electrode active material may be 90 wt. % to 99.5 wt. % with respect to 100 wt. % of the positive electrode active material layer. The amount of the binder and the conductive material may be 0.5 wt. % to 5 wt. % with respect to 100 wt. % of the positive electrode active material layer.

Aluminum may be used as the current collector, but the present disclosure may not be limited thereto.

A negative electrode active material may include a material capable of reversibly Intercalation/de-intercalation with respect to lithium ions, lithium metal, an alloy of lithium metal, a material capable of doping and dedoping with respect to lithium, or transition metal oxide. The material capable of reversibly Intercalation/de-intercalation with respect to lithium ions may include a carbon-based negative electrode active material, for example, crystalline carbon, amorphous carbon, or a combination of them. An example of the crystalline carbon may include graphite, such as natural graphite or synthetic graphite. Examples of the amorphous carbon may include soft or hard carbon, mesophase pitch carbide, and fired coke.

An Si-based negative electrode active material or an Sn-based negative electrode active material may be used as the material capable of doping and dedoping with respect to lithium. The Si-based negative electrode active material may be silicon, a silicon-carbon composite, SiOₓ (0<x<2), a Si-based alloy, or a combination thereof.

The silicon-carbon composite may be a composite of silicon and amorphous carbon. According to an example, the silicon-carbon composite may include silicon particles, and may have a form in which amorphous carbon has been coated on surfaces of silicon particles.

The silicon-carbon composite may further include crystalline carbon. For example, the silicon-carbon composite may include a core including crystalline carbon and silicon particles, and an amorphous carbon coating layer disposed on a surface of the core.

A negative electrode for a lithium secondary battery may include a current collector and a negative electrode active material layer disposed on the current collector. The negative electrode active material layer may include the negative electrode active material and may further include a binder and/or a conductive material. For example the negative electrode active material layer may include the negative electrode active material at 90 wt. % to 99 wt. %, the binder at 0.5 wt. % to 5 wt. %, and the conductive material at 0 wt. % to 5 wt. %.

A nonaqueous-based binder, an aqueous-based binder, a dry binder, or a combination of them may be used as the binder. If the aqueous-based binder is used as a binder for the negative electrode, the binder for the negative electrode may further include a cellulose-series compound capable of assigning viscosity.

One of nickel foil, stainless steel foil, titanium foil, nickel foam, copper foam, a polymer base on which a conductive metal has been coated, and a combination thereof may be used as a current collector for the negative electrode.

It will be apparent to those skilled in the art that various modifications and variations can be made in the present disclosure without departing from the spirit or scope of the disclosure. Thus, the present disclosure covers the modifications and variations.

What is claimed is:

1. A slot die comprising:
an upper die;
a lower die forming a gap with the upper die;
a slurry supply unit configured to be connected to an external slurry supply source;
one or more cavities formed in the lower die and connected to the slurry supply unit;
a slot connected to the one or more cavities and configured to coat a slurry a base material;
a temperature sensor configured to measure a temperature of the slurry;
a temperature controller provided adjacent to the slot and configured to control a temperature of the slurry discharged from the slot based on the temperature measured by the temperature sensor.

2. The slot die of claim 1, wherein the temperature controller is provided in the upper die, the lower die, or both the upper die and the lower die.

3. The slot die of claim 2, wherein the temperature controller comprises a fluid flow tube forming a flow path through which a fluid for controlling the temperature of the slurry can flow.

4. The slot die of claim 3, wherein the fluid flow tube extends in a width direction of the slot and passes through an inner portion of the upper die or the lower die.

5. The slot die of claim 4, wherein the temperature controller comprises:
a cooling unit configured to decrease a temperature of the fluid supplied through the fluid flow tube; and
a heating unit configured to increase the temperature of the fluid supplied through the fluid flow tube.

6. The slot die of claim 1, wherein the temperature sensor is configured to measure a temperature of slurry in the slot die.

7. The slot die of claim 6, wherein the temperature sensor is a first temperature sensor, and
wherein the temperature sensor comprises a second temperature measurer configured to measure a temperature of the slurry discharged from the slot.

8. A slot die temperature control apparatus comprising:
a slot die including:
an upper die;
a lower die forming a gap with the upper die;
a slurry supply unit configured to be connected to an external slurry supply source;
one or more cavities formed in the lower die and connected to the slurry supply unit;
a slot connected to the one or more cavities to coat a slurry on a base material;
a temperature controller provided adjacent to the slot to control a temperature of the slurry discharged from the slot; and
a temperature sensor configured to measure the temperature of the slurry; and
a controller configured to control the temperature controller based on the temperature of the slurry measured by the temperature sensor.

9. The slot die temperature control apparatus of claim 8, wherein the temperature controller is provided in the upper die, the lower die, or the upper die and the lower die.

10. The slot die temperature control apparatus of claim 9, wherein the temperature controller comprises a fluid flow tube forming a flow path through which a fluid for controlling the temperature of the slurry can flow.

11. The slot die temperature control apparatus of claim 10, wherein the fluid flow tube extends in a width direction of the slot and pass through an inner portion of the upper die or the lower die.

12. The slot die temperature control apparatus of claim 11, wherein the temperature controller comprises:
a cooling unit configured to decrease a temperature of the fluid supplied through the fluid flow tube; and
a heating unit configured to increase the temperature of the fluid supplied through the fluid flow tube.

13. The slot die temperature control apparatus of claim 8, wherein the temperature sensor is configured to measure a temperature of slurry in the slot die.

14. The slot die temperature control apparatus of claim 13, wherein the temperature sensor is a first temperature sensor, and
wherein the temperature sensor comprises a second temperature sensor configured to measure a temperature of the slurry discharged from the slot.

15. The slot die temperature control apparatus of claim 14, wherein the controller is configured to control the temperature controller so that the temperature of the slurry supplied from the slurry supply unit corresponds to the temperature of the slurry discharged from the slot.

16. A slot die temperature control method comprising:
a step of providing a slot die including:
an upper die;
a lower die forming a gap with the upper die;
a slurry supply unit connected to an external slurry supply source;
one or more cavities formed in the lower die and connected to the slurry supply unit;
a slot connected to the one or more cavities to coat a slurry on a base material;
a temperature controller provided adjacent to the slot to control a temperature of the slurry discharged from the slot; and
a temperature sensor configured to measure the temperature of the slurry; and
a step of controlling the temperature controller based on the temperature of the slurry measured by the temperature sensor.

17. The slot die temperature control method of claim 16, wherein the step of providing the slot die comprises a step of providing the temperature controller in the upper die, the lower die, or the upper die and the lower die.

18. The slot die temperature control method of claim 16, wherein the step of providing the slot die comprises a step of providing the temperature sensor to measure a temperature of slurry in the slot die
19. The slot die temperature control method of claim 18, wherein the temperature sensor is a first temperature sensor, and
wherein the step of providing the slot die comprises a step of providing a second temperature sensor to measure the temperature of the slurry discharged from the slot.

20. The slot die temperature control method of claim 19, wherein the step of controlling the temperature controller comprises a step of controlling the temperature controller so that the temperature of the slurry supplied from the slurry supply unit corresponds to the temperature of the slurry discharged from the slot.
